(19) United States
(12) Patent Application Publication
(10) Pub. No.: US 2026/0292678 A1
(43) Pub. Date: Sep. 24, 2026

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/679,226

(22) Filed: May 15, 2026

Related U.S. Application Data
(63) Continuation of application No. PCT/CN2024/144301, filed on Dec. 31, 2024.

(51) Int. Cl. H04W 52/02

(52) U.S. Cl. CPC H04W 52/0206; H04W 52/0235

(57) ABSTRACT

Provided are a method and an apparatus for wireless communication. One example method includes: transmitting, in a network energy saving (NES) cell, first information, wherein the first information comprises a request for a network device to transmit an on demand system information block (OD-SIB1); and monitoring first control signalling in a first time window, wherein the first control signalling indicates a terminal device to receive the OD-SIB1, a configuration parameter of the first time window is carried in configuration information of at least one of the first information or a first response, and the first response is feedback for the first information.

### CROSS-REFERENCE TO RELATED APPLICATIONS

This application claims priority to International Patent Application No. PCT/CN2024/144301, filed on Dec. 31, 2024, which is hereby incorporated by reference in its entirety.

### TECHNICAL FIELD

The present application relates to the field of communications technologies, and more specifically, to a method and an apparatus for wireless communication.

### BACKGROUND

To implement network energy saving, a network device may transmit a system information block (system information block, SIB) 1 after receiving a request of a terminal device, to reduce unnecessary SIB1 transmission and related monitoring. However, after the terminal device requests to transmit the SIB1 to the network device, how the network device transmits the on-demand SIB1 and how the terminal device receives the on-demand SIB1 are technical problems urgently to be resolved.

### SUMMARY

The present application provides a method and an apparatus for wireless communication. Various aspects of embodiments of the present application are described below.

According to a first aspect, a method for wireless communication is provided, including: transmitting, by a terminal device, first information, where the first information is used to request a network device to transmit a SIB1; and monitoring, by the terminal device, first control signalling in a first time window, where the first control signalling is used to instruct the terminal device to receive the SIB1, a configuration parameter of the first time window is carried in configuration information of the first information and/or a first response, and the first response is feedback of the network device for the first information.

According to a second aspect, a method for wireless communication is provided, including: receiving, by a network device, first information, where the first information is used by a terminal device to request a SIB1; and transmitting, by the network device, first control signalling in a first time window, where the first control signalling is used to instruct the terminal device to receive the SIB1, a configuration parameter of the first time window is carried in configuration information of the first information and/or a first response, and the first response is feedback of the network device for the first information.

According to a third aspect, an apparatus for wireless communication is provided. The apparatus is a terminal device. The apparatus includes: a transmitting unit, transmitting first information where the first information is used by a terminal device to request a SIB1; and a receiving unit, monitoring first control signalling in a first time window where the first control signalling is used to instruct the terminal device to receive the SIB1, a configuration parameter of the first time window is carried in configuration information of the first information and/or a first response, and the first response is feedback of the network device for the first information.

According to a fourth aspect, an apparatus for wireless communication is provided. The apparatus is a network device. The apparatus includes: a receiving unit, receiving first information, where the first information is used by a terminal device to request a SIB1; and a transmitting unit, transmitting first control signalling in a first time window, where the first control signalling is used to instruct the terminal device to receive the SIB1, a configuration parameter of the first time window is carried in configuration information of the first information and/or a first response, and the first response is feedback of the network device for the first information.

According to a fifth aspect, a communications apparatus is provided, including a memory and a processor. The memory is configured to store a program, and the processor is configured to invoke the program in the memory to perform the method according to the first aspect or the second aspect.

According to a sixth aspect, an apparatus is provided, including: a processor, invoking a program from a memory to perform the method according to the first aspect or the second aspect.

According to a seventh aspect, a chip is provided, including: a processor, invoking a program from a memory, to cause a device installed with the chip to perform the method according to the first aspect or the second aspect.

According to an eighth aspect, a computer-readable storage medium is provided. The computer-readable storage medium stores a program. The program causes a computer to perform the method according to the first aspect or the second aspect.

According to a ninth aspect, a computer program product is provided, including a program. The program causes a computer to perform the method according to the first aspect or the second aspect.

According to a tenth aspect, a computer program is provided. The computer program causes a computer to perform the method according to the first aspect or the second aspect.

In embodiments of the present application, the terminal device requests, by using the first information, the network device to transmit the SIB1, and then monitors, in the first time window, the first control signalling used to indicate a transmitting time of the SIB1. The configuration parameter of the first time window is carried in the configuration information of the first information and/or the first response corresponding to the first information. It can be learned that after receiving the configuration information of the first information or the response information of the first information, the terminal device may determine a location of the first time window, to receive the SIB1 in time. The network device may dynamically adjust the transmitting time of the SIB1 based on a quantity of terminal devices that transmit SIB1 requests. This facilitates improvement of system performance on the basis of implementing network energy saving.

### BRIEF DESCRIPTION OF THE DRAWINGS

FIG. 1 shows a wireless communications system to which an embodiment of the present application is applied.

FIG. 2 is a schematic diagram of a network architecture to which an embodiment of the present application is applied.

FIG. 3A and FIG. 3B are schematic structural diagrams of wireless protocol stacks to which an embodiment of the present application is applied.

FIG. 4 is a schematic structural diagram of transmission of an on-demand SIB1 by a cell based on a wake-up signal.

FIG. 5 is a schematic flowchart of a method for wireless communication according to an embodiment of the present application.

FIG. 6 is a schematic diagram of a possible implementation of repeatedly transmitting first information in the method shown in FIG. 5.

FIG. 7 is a schematic diagram of another possible implementation of repeatedly transmitting first information in the method shown in FIG. 5.

FIG. 8 is a schematic diagram of a possible implementation of the method shown in FIG. 5.

FIG. 9 is a schematic diagram of another possible implementation of the method shown in FIG. 5.

FIG. 10 is a schematic diagram of still another possible implementation of the method shown in FIG. 5.

FIG. 11 is a schematic diagram of still another possible implementation of the method shown in FIG. 5.

FIG. 12 is a schematic structural diagram of an apparatus for wireless communication according to an embodiment of the present application.

FIG. 13 is a schematic structural diagram of another apparatus for wireless communication according to an embodiment of the present application.

FIG. 14 is a schematic structural diagram of a communications apparatus according to an embodiment of the present application.

### DETAILED DESCRIPTION OF THE EMBODIMENTS

The following describes the technical solutions in embodiments of the present application with reference to the accompanying drawings in embodiments of the present application. Apparently, the described embodiments are some rather than all of embodiments of the present application.

Embodiments of the present application may be applied to various communications systems. For example, embodiments of the present application may be applied to a global system for mobile communications (global system for mobile communications, GSM) system, a code division multiple access (code division multiple access, CDMA) system, a wideband code division multiple access (wideband code division multiple access, WCDMA) system, or a general packet radio service (general packet radio service, GPRS) system. For another example, embodiments of the present application may be applied to a long term evolution (long term evolution, LTE) system, an advanced long term evolution (advanced long term evolution, LTE-A) system, a 5th generation (5th-generation, 5G) communications system or a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunication system (universal mobile telecommunication system, UMTS) system, a wireless local area network (wireless local area network, WLAN) system, and a wireless fidelity (wireless fidelity, WiFi) system. Embodiments of the present application may be further applied to another communications system, for example, a future communications system such as a 6th generation (6th-generation, 6G) communications system or a satellite (satellite) communications system.

Conventional communications systems support a limited quantity of connections and are easy to implement. However, with development of communications technologies, a communications system may support not only conventional cellular communication but also one or more other types of communication. For example, the communications system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, and vehicle-to-everything (vehicle to everything, V2X) communication. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to an unlicensed spectrum. The unlicensed spectrum may also be considered as a shared spectrum. Alternatively, the communications system in embodiments of the present application may be applied to a licensed spectrum. The licensed spectrum may also be considered as a dedicated spectrum.

Embodiments of the present application may be applied to a non-terrestrial network (non-terrestrial network, NTN) system. For example, the NTN system may be a 4G-based NTN system, an NR-based NTN system, an NTN system based on an Internet of things (internet of things, IoT), or an NTN system based on a narrow band Internet of things (narrow band internet of things, NB-IoT).

The communications system may include one or more terminal devices. The terminal device in embodiments of the present application may also be referred to as user equipment (user equipment, UE), an access terminal, a subscriber unit, a subscriber station, a mobile site, a mobile station (mobile station, MS), a mobile terminal (mobile Terminal, MT), a remote station, a remote terminal, a mobile device, a user terminal, a terminal, a wireless communications device, a user agent, a user apparatus, or the like.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device or another processing device connected to a wireless modem, a vehicle-mounted device, a wearable device, a terminal device in a next-generation communications system (such as an NR system), a terminal device in a future evolved public land mobile network (public land mobile network, PLMN), or the like.

In some embodiments, the terminal device may be a device that provides a user with voice and/or data connectivity. For example, the terminal device may be a handheld device, a vehicle-mounted device, or the like that has a wireless connection function. In some specific examples, the terminal device may be a mobile phone (mobile phone), a tablet computer (Pad), a notebook computer, a palmtop computer, a camera device, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like.

In some embodiments, the terminal device may be deployed on land. For example, the terminal device may be deployed indoors or outdoors. In some embodiments, the terminal device may be deployed on water, for example, on a ship. In some embodiments, the terminal device may be deployed in the air, for example, on an airplane, a balloon, and a satellite.

In addition to the terminal device, the communications system may further include one or more network devices. The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names in the following, or may be interchangeable with the following names, for example, a NodeB (NodeB), an evolved NodeB (evolved NodeB, eNB), a next generation NodeB (next generation NodeB, gNB), a relay station, an access point (access point, AP), a transmitting and receiving point (transmitting and receiving point, TRP), a transmitting point (transmitting point, TP), a master eNode (MeNB), a secondary eNode (SeNB), a multi-standard radio (MSR) node, a home base station, a network controller, an access node, a wireless node, a transmitting node, a transceiver node, a baseband unit (baseband unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in D2D, V2X, or M2M communication, a network-side device in a 6G network, a device that functions as a base station in a future communications system, or the like. The base station may support networks of a same access technology or different access technologies. A specific technology and a specific device form used by the network device are not limited in embodiments of the present application.

The base station may be a fixed or mobile base station. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

As an example rather than limitation, in embodiments of the present application, the network device may have a mobile feature, for example, the network device may be a movable device. In some embodiments of the present application, the network device may be a satellite or a balloon station. In some embodiments of the present application, the network device may alternatively be a base station disposed on land, water, or the like.

In embodiments of the present application, the network device may provide a service for a cell. The terminal device communicates with the network device by using a transmission resource (for example, a frequency resource or a spectrum resource) used by the cell. The cell may be a cell corresponding to the network device (for example, a base station). The cell may belong to a macro station or may belong to a base station corresponding to a small cell (small cell). The small cell herein may include a metro cell (metro cell), a micro cell (micro cell), a pico cell (pico cell), a femto cell (femto cell), or the like. These small cells have features of small coverage and a low transmit power, and are suitable for providing a high-rate data transmission service.

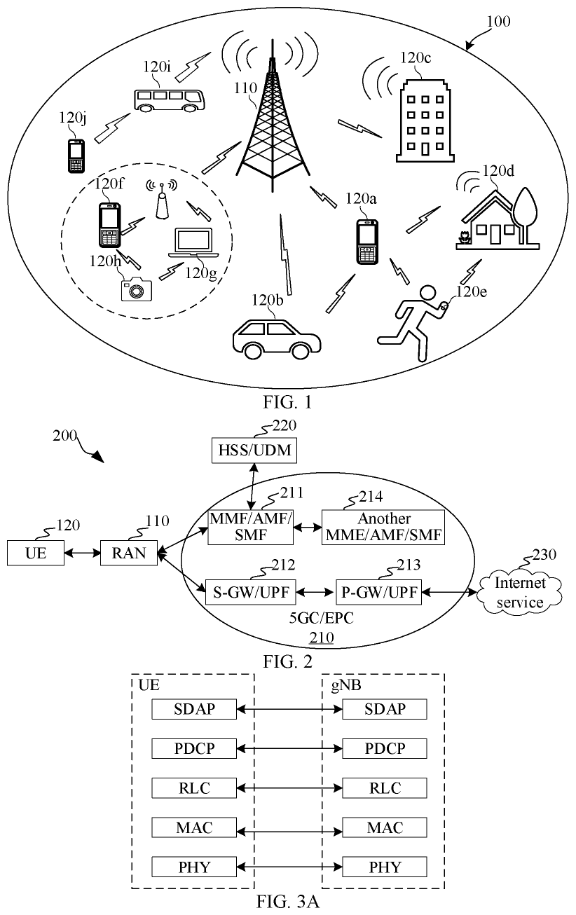

For example, FIG. 1 is a schematic diagram of an architecture of a wireless communications system according to an embodiment of the present application. The wireless communications system 100 shown in FIG. 1 includes one network device and a plurality of terminal devices. The network device 110 may provide communication coverage in a specific geographic area, and may communicate with a terminal device located in the coverage. The plurality of terminal devices, for example, a terminal device 120a to a terminal device 120j in FIG. 1.

Optionally, the wireless communications system 100 in FIG. 1 may include a plurality of network devices, and another quantity of terminal devices may be included within coverage of each network device. This is not limited in this embodiment of the present application.

In embodiments of the present application, the communications system shown in FIG. 1 may further include a plurality of network entities. This is not limited in this embodiment of the present application.

For example, FIG. 2 is a schematic diagram of a network structure to which an embodiment of the present application is applied. The network architecture 200 in FIG. 2 is a network architecture of a 5G NR/LTE/LTE-A system. The 5G NR/LTE/LTE-A network architecture may also be referred to as a 5G system (5G system, 5GS)/evolved packet system (evolved packet system, EPS) network architecture. The network architecture 200 includes at least one of a network device 110, a terminal device 120, a 5G core network (5G core network, 5GC)/evolved packet core (evolved packet core, EPC) 210, a home subscriber server (home subscriber server, HSS)/unified data management (unified data management, UDM) 220, and an Internet service 230. The network device and the terminal device in FIG. 2 are respectively shown by using a RAN and a UE as an example.

As shown in FIG. 2, the network device 110 provides termination of a user plane protocol and a control plane protocol toward the terminal device 120. The network device 110 is connected to the 5GC/EPC 210 by using an S1/NG interface. The 5GC/EPC 210 includes a mobility management entity (mobility management entity, MME)/Access and Mobility management Function, AMF)/session management function (session management Function, SMF) 211, another MME/AMF/SMF 214, a service gateway (service gateway, S-GW)/user plane function (user plane function, UPF) 212, and a packet data network gateway (packet data network gateway, P-GW)/UPF 213. The MME/AMF/SMF 211 is a control node that processes signalling between the terminal device 120 and the 5GC/EPC 210. Generally, the MME/AMF/SMF 211 provides bearing and connection management. All user Internet protocol (internet protocol, IP) packets are transmitted by using the S-GW/UPF 212, and the S-GW/UPF 212 is connected to the P-GW/UPF 213. The P-GW provides UE IP address allocation and other functions. The P-GW/UPF 213 is connected to the Internet service 230. The Internet service 230 includes an Internet protocol service corresponding to an operator, and may specifically include the Internet, the Intranet, an IP multimedia subsystem (IP multimedia subsystem, IMS), and a packet switching streaming service. It can be learned that the network architecture 200 provides a packet switching service, but a person skilled in the art readily understands that various concepts presented throughout the present application may be extended to a network or another cellular network that provides a circuit switching service.

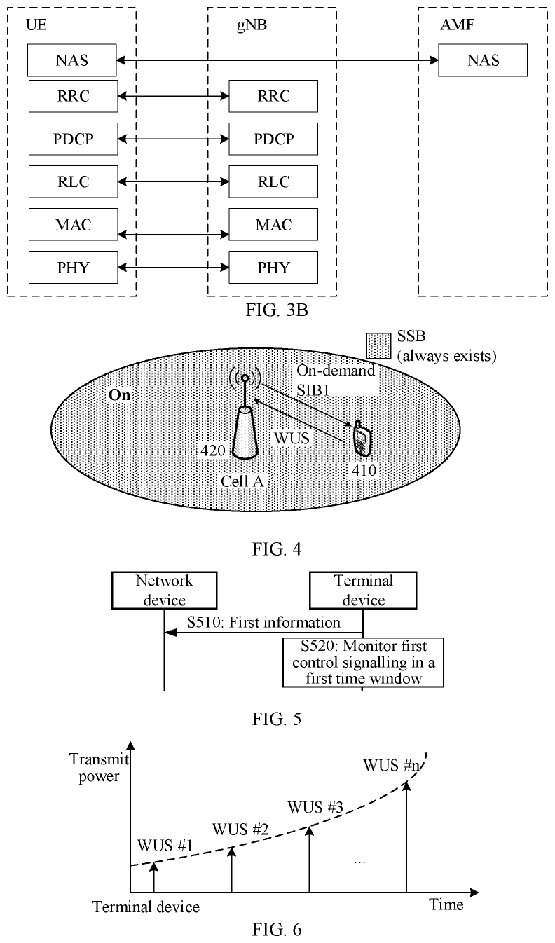

FIG. 3A and FIG. 3B are schematic structural diagrams of wireless protocol stacks to which embodiments of the present application are applied. FIG. 3A and FIG. 3B are described by using 5G wireless protocol stacks as an example. The 5G wireless protocol stacks are divided into two planes: a user plane (user plane, UP) protocol stack and a control plane (control plane, CP) protocol stack. The user plane protocol stack is a protocol suite used for user data transmission. The control plane protocol stack is a protocol suite used for control signalling transmission of a 5G system. Names of protocol stack layers are as follows:

As shown in FIG. 3A, the user plane protocol stack sequentially includes a service data adaptation protocol (service data adaptation protocol, SDAP) layer, a packet data convergence protocol (packet data convergence protocol, PDCP) layer, a radio link control (radio link control, RLC) layer, a medium access control (medium access control, MAC) layer, and a physical (physical, PHY) layer from top to bottom.

As shown in FIG. 3B, the control plane protocol stack sequentially includes a non-access stratum (non-access stratum, NAS), a radio resource control (radio resource control, RRC) layer, a PDCP layer, an RLC layer, a MAC layer, and a PHY layer from top to bottom.

It should be understood that different layers in the protocol stack have different functions, and a communication function between the terminal device and the network device is jointly implemented through inter-layer interaction. With development of an artificial intelligence technology, an artificial intelligence auxiliary computing function has penetrated into the foregoing protocol stack processing implementation method. For example, a scheduling algorithm of the MAC layer and an encoding and decoding algorithm of the PHY layer may use an artificial intelligence algorithm to improve performance of a communication algorithm.

In an embodiment, the wireless protocol architectures in FIG. 3A and FIG. 3B are applicable to the terminal device in the present application, for example, a UE.

In an embodiment, the wireless protocol architectures in FIG. 3A and FIG. 3B are applicable to the network device in the present application, for example, a gNB.

It should be understood that a device having a communication function in a network/system in embodiments of the present application may be referred to as a communications device. For explanation of the terms (Terminology) in embodiments of the present application, reference may be made to specification protocols TS36 series, TS37 series, and TS38 series of the 3rd generation partnership project (3rd generation partnership project, 3GPP), and reference may also be made to specification protocols of the institute of electrical and electronics engineers (Institute of Electrical and Electronics Engineers, IEEE).

For ease of understanding, some relevant technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

With the development of mobile communications technologies, a new radio evolution system (for example, a 5G system) increases a data transmission rate by using various technologies, thereby meeting a transmission requirement of a large data amount such as a high-definition video or virtual reality. For example, these various technologies include a large-scale (multiple-input multiple-output, MIMO) technology, a non-orthogonal multiple access technology, a co-time co-frequency full-duplex communications technology, a novel modulation technology, a novel coding technology, a high-order modulation technology, or the like. A peak rate can be up to a standard of Gbit/s by using these technologies.

In an example, a latency level of an air interface needs to be about 1 ms to meet real-time application such as autonomous driving and telemedicine.

In an example, an ultra-large network capacity can provide a connection capability of hundreds of billions of devices, thereby meeting an internet of things communication requirement.

In an example, spectral efficiency of an NR system is over 10 times higher than that of an LTE system. Based on continuous wide-area coverage and high mobility, an experience rate of a user can reach 100 Mbit/s. It may be learned that a traffic density and a connection density are increased greatly.

In addition, improvement of system collaboration and an intelligence level further improves flexibility of a network. System collaboration may be embodied as collaborative networking with a plurality ofusers, a plurality of points, a plurality of antennas, and a plurality of acquisitions. Based on collaboration and intelligence, automatic adjustment can be performed between networks flexibly.

However, in a communication system, power consumption of a network device (for example, a base station device) is usually high. To reduce power consumption of the base station device, system information needs to be optimized. For ease of understanding, the following uses system information of NR as an example for description.

The system information of NR can be classified into master information block (master information block, MIB) messages and some SIB messages. A MIB message is usually sent on a broadcast channel (broadcast channel, BCH). A transmission periodicity of the MIB is 80 ms. The MIB may be repeatedly transmitted within a periodicity of 80 ms. In addition, the MIB message further includes a parameter required by the terminal device to obtain a SIB1 message from a cell.

The SIB1 message may also be referred to as a SIB type 1 message. The SIB1 is transmitted on a downlink shared channel (downlink-shared channel, DL-SCH) at a periodicity of 160 ms. Within 160 ms, the SIB may be further repeatedly transmitted with a variable transmission repetition periodicity. A default transmission repetition periodicity for the SIB1 is 20 ms. An actual transmission repetition periodicity depends on network implementation. For example, for a multiplexing mode 1 of a synchronization signal block (synchronization signal block, SSB) and a control resource set (control resource set, CORESET), the transmission repetition periodicity of the SIB1 is 20 ms. For another example, for a multiplexing mode 2/3 of the SSB and the CORESET, the transmission repetition periodicity of the SIB1 is the same as a periodicity of the SSB.

In this embodiment of the present application, the SSB may further represent a synchronization signal/physical broadcast channel block (synchronization signal and PBCH block).

The SIB1 may carry key information required by the terminal device to access a cell, for example, a random access parameter. The SIB1 may further carry information related to availability and scheduling of another SIB, for example, mapping from the another SIB to a system information (system information, SI) message, periodicity, and SI window size. The SIB1 may further indicate whether one or more SIBs are provided only on demand. In this case, the SIB1 may further provide a physical random access channel (physical random access channel, PRACH) configuration required by the terminal device, so as to request SI required by the terminal device. The SIB1 further includes radio resource configuration information common to all terminal devices and cell barring information applied to unified access control.

When the SIB1 includes information related to another SIB, the another SIB message may be broadcast periodically or provided on demand. If another SIB is provided on demand, the SIB1 may further include information used by the terminal device to execute the SI request.

A SIB message (another SIB) other than the SIB1 may be included in the SI message. This message may also be transmitted on a DL-SCH. Each SI message may be periodically transmitted within a time domain window (referred to as an SI window). For example, only SIBs with the same periodicity can be mapped to the same SI message. When each SI message is transmitted within a time domain window that occurs periodically, all SI messages may correspond to SI windows of the same length. Each SI message is associated with an SI window, and SI windows of different SI messages do not overlap. That is, only a corresponding SI message is sent in one SI window. In addition, a system may send the SI message a plurality of times within the SI window.

The system information of NR is used above as an example to describe a plurality of SIB messages. A network device (for example, a gNB) may periodically send a SIB1 used for initial access, and schedule another SIB of a terminal device in an idle (idle)/inactive (inactive, which may also be referred to as non-active) mode. The network device always performs SIB1 transmission even if there is no demand from the terminal device or no terminal device is camping on a cell. It may be learned that, in some scenarios, the network device periodically sends the SIB1, which may cause a relatively large energy waste.

To achieve network energy saving, unnecessary SIB1 transmissions and associated PRACH monitoring need to be reduced. Therefore, transmitting the SIB1 to the terminal device in an idle/inactive state on demand becomes a research direction, to provide the network device with more opportunities in a sleep mode. For example, how to implement on-demand SIB1 (on demand SIB1, OD-SIB1) transmission to save energy of the network device needs to be considered.

In some embodiments, a cell that implements on demand SIB1 transmission is referred to as an energy saving cell, or is referred to as a network energy saving (network energy saving, NES) cell. For the terminal device in the idle mode or the inactive state, because the NES cell does not carry SIB1 information when transmitting an SSB, the terminal device needs to transmit related request information/signalling, to request the NES cell to transmit the SIB1 information.

Optionally, on-demand SIB1 request information may be an uplink (uplink, UL) wake-up signal (wake up signal, WUS), or may be other on-demand (on demand) information/signalling of the SIB1 requested to be transmitted. The uplink wake-up signal may be represented as UL-WUS. The UL-WUS is any uplink signal that can trigger on-demand SIB1 transmission.

Optionally, the terminal device may transmit, by using a random access channel (random access channel, RACH) or a separate signal or sequence, request information triggering the on-demand SIB1. For example, the terminal device may transmit the WUS by using a PRACH.

In some embodiments, the terminal device may directly request the on-demand SIB1 from the NES cell, or may request the on-demand SIB1 from an anchor cell related to the NES cell. For example, to obtain the SIB1 information of the NES cell, the terminal device may transmit an uplink WUS to the NES cell or the anchor cell. In other words, the SIB1 information obtained by the terminal device may come from the NES cell or the anchor cell.

For ease of understanding, the uplink WUS is used as an example below to describe transmission of the on-demand SIB1 with reference to FIG. 4. A terminal device 410 in FIG. 4 is located in a cell A (Cell #A) for which a network device 420 provides a service.

As shown in FIG. 4, the cell A always periodically transmits an SSB that does not include a SIB1, that is, the cell A transmits the SIB1 on demand. When the terminal device attempts to access the cell A that transmits the SIB1 on demand, the terminal device may transmit an uplink WUS to the cell A to trigger the cell A to transmit the SIB1. When the cell detects a WUS or an on-demand SIB1 request, the cell may transmit the on-demand SIB1 to the terminal device 410.

With reference to FIG. 4, the foregoing describes a method for transmitting an on-demand SIB1 by a cell based on request information. How the terminal device in the idle state or the inactive state obtains a time-frequency resource used for the request information such as a WUS is a problem that needs to be considered.

In some embodiments, when the terminal device transmits the request information such as a WUS, the terminal device needs to obtain a time-frequency resource used to transmit the request information. The WUS is used as an example. Indication information of a WUS transmission resource may be carried in the SSB transmitted by the cell A. If the SSB does not carry the resource configuration information of the request such as the WUS, when the terminal device attempts to access the cell A that transmits the SIB1 on demand, the terminal device may transmit a first request by using a PRACH. If the SSB carries the resource configuration information of the request such as the WUS, the terminal device may transmit the WUS based on the resource configuration information, or the terminal device may transmit a separate signal or sequence on a resource indicated by the resource configuration information.

The following uses an NR system as an example to describe a method for configuring a time-frequency resource based on a control resource set (CORESET) and a search space (searchspace). The CORESET mainly describes frequency resource distribution, and the search space mainly describes time resource distribution. Therefore, a specific time-frequency resource can be determined based on pairing of the CORESET and the search space.

In NR, a network end usually configures a plurality of CORESETs and a plurality of search spaces in a bandwidth part (bandwidth part, BWP). A plurality of time-frequency resources that are separately used for different purposes may be determined through pairing of the CORESET and the search space.

For example, the CORESET and the search space may be in a one-to-one correspondence. For example, a time-frequency resource determined based on a pair of a CORESET and a search space may be used to transmit a downlink control information (downlink control information, DCI) format 0_0/1_0 (that is, DCI_format 0_0/1_0); and a time-frequency resource determined based on another pair of a CORESET and a search space may be used to transmit a DCI_format 0_1/1_1.

For example, the CORESET and the search space may be in a one-to-many correspondence. For example, one CORESET may correspond to a plurality of search spaces.

For example, a search space 0 (Searchspace0) is configured for a MIB. A time-frequency resource determined based on a combination of the search space 0 and a CORESET 0 may be used by the terminal device to receive remaining minimum system information (remaining minimum system information, RMSI). The RMSI includes the SIB1. In other words, the search space 0 and the CORESET 0 may be used to indicate scheduling information of the SIB1.

For example, based on a search space and an associated CORESET configured by the network end, the terminal device may determine a time-frequency resource scheduling condition of a physical downlink control channel (physical downlink control channel, PDCCH). In a cell that transmits the SIB1 on demand, the PDCCH transmitted by the network device may be used to carry the scheduling information of the SIB1, to facilitate the terminal device in receiving the SIB1. For example, a monitoring occasion of the PDCCH corresponding to the SIB1 may be indicated by using parameters searchSpaceZero and controlResourceSetZero.

In an example, when the terminal device accesses the NES cell by transmitting the uplink WUS, the terminal device first needs to determine a monitoring occasion of the PDCCH, and then determines, based on the received PDCCH, an occasion of receiving the SIB1. However, how the terminal device determines the PDCCH monitoring occasion and how the network device performs SIB1 transmission are all technical problems that need to be resolved.

In conclusion, because the SIB1 is transmitted on demand, the network device transmits the SIB1 only after receiving a request. After the terminal device transmits the request, how the network device transmits the SIB1 on-demand and how the terminal device monitors the on-demand SIB1 are all technical problems that need to be urgently resolved.

Based on this, embodiments of the present application provide a method for wireless communication. In this method, a terminal device requests, by using first information, a network device to transmit a SIB1 (that is, an on-demand SIB1), and then monitors, in a first time window, first control signalling used to indicate a transmitting time of the SIB1. A configuration parameter of the first time window is carried in configuration information of the first information and/or a first response corresponding to the first information. It can be learned that after receiving the configuration information of the first information or the response information of the first information, the terminal device may determine a location of the first time window, to receive the SIB1 in time. The terminal device is one of a plurality of terminal devices. The network device may dynamically adjust the transmitting time of the SIB1 based on a quantity of terminal devices that transmit SIB1 requests. This facilitates improvement of system performance on the basis of reducing network-side power consumption.

For ease of understanding, the following describes in detail the method provided in embodiments of the present application with reference to FIG. 5. FIG. 5 is described from a perspective of interaction between a terminal device and a network device.

The terminal device is any communications terminal that can request an on-demand SIB. This is not limited herein. In some embodiments, the terminal device may be in an idle state or an inactive state. For example, the terminal device may be a UE in an idle/inactive mode.

In an example, the terminal device is in the idle state. When the terminal device performs initial access of an NES cell, because an SSB transmitted by the NES cell does not include a SIB1, the terminal device may request a network device serving the NES cell, to transmit the SIB1 on demand.

In an example, the terminal device is in the inactive state. When the terminal device resumes a connection with the NES cell, the terminal device may wake up the NES cell, and request the network device serving the NES cell to transmit the SIB1 on demand.

In some embodiments, the terminal device may be a communications terminal that supports an NES function. For example, in a case that an SSB or a MIB does not carry the SIB1, the terminal device may request the SIB1 from the network device based on the NES function.

In some embodiments, the terminal device may be a low-power communications terminal. For example, device power consumption may be reduced for the terminal device by using a low-power wake-up receiver (low power wake-up receiver, LP-WUR).

In some embodiments, the terminal device may be used in a plurality of application scenarios. The terminal device may be used in any one of a plurality of service types, for example, enhanced mobile broadband (enhanced mobile broadband, eMBB), ultra-reliable low-latency communication (ultra reliable low latency communication, URLLC), and enhanced machine-type communication (enhanced machine-type communication, eMTC).

In some embodiments, the terminal device is any terminal device in a plurality of terminal devices that request the SIB1. After the plurality of terminal devices transmit SIB1 requests, the network device may determine, based on a quantity of terminal devices that request the SIB1, how to schedule SIB1 transmission.

The network device may be any network-side device that communicates with the terminal device, for example, a base station. This is not limited in the present application.

In some embodiments, the network device may receive the on-demand SIB request transmitted by the terminal device, and trigger on-demand SIB transmission. In an example, the network device may be a communications device that supports the NES function. For example, the network device may increase a sleep time of a serving cell based on the NES function. For another example, the network device may implement an energy saving configuration for on-demand SIB1 transmission of the cell.

In an example, the network device may transmit a periodic SSB to the terminal device in the cell, and the SSB does not include configuration information of the SIB1. It can be learned that a cell served by the network device is the NES cell. For example, the network device may be the network device 110 in FIG. 1.

In an example, the cell served by the network device may be an anchor cell near the NES cell. The plurality of NES cells associated with the anchor cell may include the NES cell corresponding to the terminal device. For example, the anchor cell may receive the SIB1 request for the NES cell.

In an example, the cell served by the network device is an NTN cell. For example, the network device may be a satellite covering an area in which the terminal device is located in the NTN, or a terrestrial gateway or a terrestrial network device communicating with a satellite in the NTN.

In an example, the network device may monitor the SIB1 request transmitted by the terminal device, to perform responding in time. In other words, even if the cell in which the terminal device is located is in a sleep mode, the network device monitors the SIB1 request transmitted by the terminal device.

In some embodiments, the cell in which the terminal device is located is a first cell. In other words, the serving cell corresponding to the terminal device is the first cell. The terminal device and the first cell are in a connected state, or the terminal device attempts to access the first cell.

In an example, the first cell may be an energy-saving cell served by the network device. For example, the first cell may be the NES cell described above. FIG. 4 is used as an example. A cell A is an NES cell, and a terminal device may be a terminal device 410 in the cell A.

In an example, the first cell may be associated with the anchor cell served by the network device to monitor the SIB1 request by using the anchor cell.

With reference to FIG. 5, in step S510, a terminal device transmits first information to a network device.

The first information is used to request the network device to transmit a SIB1. Therefore, the first information may also be referred to as a SIB1 request. The network device triggers SIB1 transmission based on a request of the terminal device. Therefore, the SIB1 requested by using the first information may also be referred to as an on-demand SIB1.

In some embodiments, the first information may be an uplink wake-up signal or uplink information or signalling similar to a function of a wake-up signal. For example, the first information may be replaced with a first WUS or a first UL-WUS. For another example, the first information may be a first sequence for requesting the SIB1.

In some embodiments, the first information may be transmitted separately, or may be transmitted together with other uplink information. In an example, the first information may be transmitted with uplink information of a random access process. For example, the UL-WUS may be transmitted with a message 1 (Msg1) in a four-step random access process or a message A (MsgA) in a two-step random access process. In other words, the UL-WUS is transmitted by using a random access request.

In an example, when the first information is transmitted with the message 1 or the message A, a transmit power of the first information is equal to a transmit power of the message 1 or the message A. A transmitting frequency or a quantity of transmissions of the first information is determined based on a transmitting parameter of the message 1 or the message A.

In an example, when the first information is transmitted separately, the terminal device needs to allocate an appropriate transmit power for transmitting the first information.

In some embodiments, when the first information is transmitted separately, the first information may be repeatedly transmitted according to a specific periodicity. In other words, the terminal device may transmit a plurality of SIB1 requests. The plurality of SIB1 requests refer to a plurality of pieces of information including the first information, for example, a plurality of WUSs. For example, after transmitting the first information, the terminal device may further sequentially transmit second information and third information for requesting the SIB1.

In an example, content included in the plurality of pieces of information may be the same or different. For example, when the plurality of pieces of information include the first information and the second information, the first information and the second information may include only the same SIB1 request, or may respectively have different identifiers. When the plurality of pieces of information respectively have different identifiers, a response transmitted by the network device may carry the identifier, to facilitate identification of the terminal device.

In an example, the terminal device may repeatedly transmit the UL-WUS according to a specific periodicity until the network receives the UL-WUS and has corresponding feedback.

In an example, the terminal device may repeatedly transmit the UL-WUS within a predefined time, and then receive a response message.

In some embodiments, the terminal device may transmit the first information based on configuration information of the first information. In other words, the configuration information of the first information may indicate an uplink transmission resource of the first information. The configuration information of the first information may be an indication from the network device or a higher layer.

In some embodiments, in order that the network receives request information of the SIB1 as soon as possible, a plurality of transmit powers of the plurality of pieces of information transmitted by the terminal device may gradually increase. In an example, the plurality of transmit powers may gradually increase based on a fixed step. In an example, when the terminal device sequentially allocates the plurality of transmit powers to the plurality of pieces of information, a step of each increase is in a multiple relationship with a step of previous increase.

In an example, when the terminal device sequentially transmits the first information and the second information, a transmit power of the second information is greater than a transmit power of the first information. When the transmit power of the first information is an initial transmit power, the transmit power of the second information is greater than the initial transmit power.

The following uses an example in which the first information is a WUS to describe a repeated transmission manner of the first information with reference to FIG. 6. In FIG. 6, a terminal device sequentially transmits n WUSs according to a specific periodicity, respectively WUS #1,WUS #2, . . . , and WUS #n. The first information may be any WUS in the n WUSs. The second information is a subsequent WUS. As shown in FIG. 6, when the terminal device transmits the n WUSs, transmit powers gradually increase by a fixed step.

In some embodiments, to save the transmit power of the terminal device, the transmit powers of the plurality of pieces of information repeatedly transmitted according to a specific periodicity may be constant. In other words, the plurality of transmit powers of the plurality of pieces of information are the same.

In an example, when the terminal device sequentially transmits the first information and the second information, a transmit power of the second information is equal to a transmit power of the first information. When the transmit power of the first information is an initial transmit power, the transmit powers of the plurality of pieces of information are all equal to the initial transmit power.

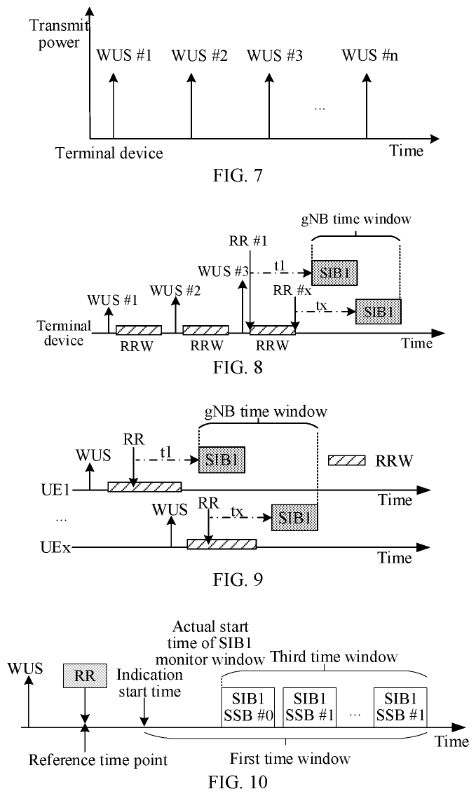

The following still uses an example in which the first information is a WUS to describe another repeated transmission manner of the first information with reference to FIG. 7. In comparison with FIG. 6, when the terminal device in FIG. 7 transmits the n WUSs, the transmit powers are constant. As shown in FIG. 7, the transmit powers of the n WUSs are the same.

In some embodiments, when transmitting a plurality of pieces of information, the terminal device may increase transmit powers in phases. In an example, the transmit power increases after the transmit power keeps constant in several current periodicities, and then an increased power lasts several periodicities.

In some embodiments, in order that the network receives request information of the SIB1 as soon as possible, the terminal device may adjust transmission periodicities of the plurality of pieces of information. In an example, transmission periodicities of at least two pieces of information whose transmitting times are later in the plurality of pieces of information are less than transmission periodicities of at least two pieces of information whose transmitting times are earlier. In other words, transmission of the plurality of pieces of information whose transmitting times are later is more intensive. For example, if the terminal device does not receive feedback from the NES/anchor cell within a predefined time, a transmission periodicity of the UL-WUS may be reduced, so that transmission of the UL-WUS is more intensive.

For the network device, after receiving any information in the first information or the plurality of information transmitted by the terminal device, the network device may perform SIB1 transmission. For example, after receiving the UL-WUS, a base station of the NES cell may perform on-demand SIB1 transmission in time domain.

In some embodiments, after receiving the SIB1 request, the network device may transmit response information about the SIB1 request to the terminal device, so that the terminal device stops transmitting the SIB1 request. For example, when the NES cell receives the UL-WUS, the network device may transmit feedback of the first information, that is, a response of the first information, by using a physical downlink shared channel (physical downlink shared channel, PDSCH).

In an example, one PDSCH can carry a plurality of responses corresponding to a plurality of terminal devices.

In the foregoing embodiment, the response information of the SIB1 request may also be referred to as a request response (request response, RR) or a received response (received response, RR). The response information corresponding to the first information is a first response. In other words, feedback performed by the network device on the first information is the first response.

In an example, the first response includes one or more of the following information: an identifier of the first information (for example, a special identifier of the UL-WUS), time adjustment information, initial uplink scheduling, uplink and downlink scheduling resources, and parameters such as searchSpaceZero, a start offset of a PDCCH window, and a PDCCH window duration.

In an example, the first response is a response. In other words, the network device may transmit one response for one SIB1 request.

In an example, the first response is a plurality of responses. In other words, the network device may transmit a plurality of responses for one SIB1 request.

In an example, when the first response includes a plurality of responses, the plurality of responses carry the identifier of the first information.

In some embodiments, after transmitting the first information, the terminal device may monitor the first response from the network device in a second time window. In other words, the first response is associated with the second time window. The second time window used to monitor the request response may also be referred to as a request response window (request response window, RRW). It can be learned that after receiving the first information, the network device transmits the first response in the second time window.

In an example, after the terminal device transmits the UL-WUS, the terminal device waits for the first response in the second time window. When the first response includes first control signalling, the terminal device also monitors the first control signalling. If an identifier carried in a response received by the terminal device is the same as an identifier of a transmitted UL-WUS, the response succeeds. If the terminal device does not receive a response in the second time window or fails to verify a response, the response fails. In this case, if a quantity of times of transmitting the first information is less than a predefined or preconfigured upper limit, the terminal device retransmits the first information. Otherwise, the request for the SIB1 fails. For example, after transmitting a UL-WUS, the terminal device monitors a response in an RRW. If no reply information/signalling of the base station is received in the RRW, it is considered that this transmission of the UL-WUS fails.

In some embodiments, the second time window may be used by the network device to transmit a plurality of responses. In other words, the first response belongs to the plurality of responses transmitted by the network device in the second time window. The plurality of responses are used to feed back a plurality of SIB1 requests transmitted by the terminal device, or a plurality of SIB1 requests transmitted by the plurality of terminal devices. In other words, when receiving information of the plurality of SIB1 requests, the network device respectively transmits the plurality of responses.

In an example, the plurality of pieces of information corresponding to the plurality of responses are a plurality of SIB1 requests transmitted by one terminal device.

In an example, the plurality of pieces of information corresponding to the plurality of responses are a plurality of SIB1 requests separately transmitted by the plurality of terminal devices. For example, after a plurality of UL-WUSs transmitted by the plurality of terminal devices are received, the NES cell may transmit RRs respectively to the plurality of terminal devices in an RRW.

In the foregoing example, the NES cell transmits the plurality of responses in the second time window. Using the same offset between the plurality of responses and the plurality of PDCCH windows means that start times of the plurality of PDCCH windows respectively change according to receiving times of the plurality of responses. In this scenario, the NES cell may need a larger window to transmit the OD-SIB1. For example, to align enough terminal devices and receive the OD-SIB1 in a specific time window, a gNB needs to predefine/preconfigure a time window with a length of L to transmit the SIB1, to improve resource utilization of a system.

In an example, when a plurality of pieces of information come from one terminal device, the network device may also transmit one response. In this scenario, a quantity of responses transmitted by the network device in the second time window is the same as a quantity of terminal devices that request the SIB1 in a specific time period. In other words, the network device may transmit the response to the terminal device that transmits the SIB1 request, to reduce resource overheads.

In the foregoing example, a specific time period may be before the second time window, or may partially overlap the second time window. A duration of the specific time period may be determined by the network device itself, or may be indicated to the terminal device by using a higher layer, so that the terminal device determines the second time window.

In an example, a configuration parameter of the second time window may be carried in configuration information of the first information. For example, WUS configuration information may indicate a configuration of the second time window, so that the terminal device monitors response information in time.

In an example, a start time of the second time window may be determined based on a transmitting time and a transmission delay of the first information. In this embodiment of the present application, a start time of a time window is a time point at which the time window starts, and an end time is a time point at which the time window ends.

In some embodiments, the network device may also configure an offset between the first information and the first response, for example, a fifth offset. The fifth offset may be an offset time configured by a cell, and is usually used to ensure scheduling and response preparation times of the cell after the UL-WUS is received. In this scenario, the fifth offset may be based on a fixed offset after the transmitting time of the first information.

In some embodiments, the second time window may be used by the terminal device to monitor one or more responses corresponding to the first information. For example, after receiving the UL-WUS, the NES cell may transmit a plurality of RRs in the RRW, to improve reliability of receiving the RRs on a terminal device side.

In an example, a location of the one or more responses corresponding to the first information in the second time window may be determined by the network device. For example, when a service type of the terminal device is a service with a higher priority, the network device may transmit the first response earlier.

In some embodiments, the first response may include an identifier used to identify the response, so that the terminal device performs subsequent uplink transmission based on the response. The NES cell may parse the identifier based on uplink transmission, to confirm a specific response successfully received by the terminal device.

In an example, after receiving the first response, the terminal device may feed back an acknowledgement (acknowledgement, ACK) to the network device. The ACK fed back by the terminal device may carry the identifier used to identify the first response.

In an example, the identifier included in the first response may be a sequence number or a time stamp. For example, each response transmitted by the NES cell in the second time window may respectively include a unique identifier.

In some embodiments, in addition to feeding back the first information, the first response may further indicate the terminal device to monitor the first control signalling in the first time window. For example, the first response may indicate a configuration parameter of the first time window. Hereinafter, description is provided bellow with reference to step S520.

In some embodiments, the first response may include the first control signalling, and receiving the first response by the terminal device is receiving the first control signalling.

In step S520, the terminal device monitors the first control signalling in the first time window. The first control signalling is used to indicate the terminal device to receive the SIB1.

The first control signalling may include scheduling information of the SIB1, to indicate the terminal device to receive the SIB1. In some embodiments, the first control signalling may be a PDCCH for scheduling the SIB1. After receiving the PDCCH, the terminal device may determine, based on information in the PDCCH, one or more SIB1 transmission occasions of the SIB1 transmitted by the cell, to receive the SIB1.

The first time window may be used by the terminal device to monitor the first control signalling. In an example, the first time window may include one or more PDCCH monitoring occasions (monitoring occasion, MO). Therefore, the first time window may also be referred to as a PDCCH window. The PDCCH monitoring occasion is used by the terminal device to monitor the PDCCH and the SIB1, or may be referred to as a PDCCH monitoring occasion of the on-demand SIB1.

In some embodiments, a parameter of the first time window is determined based on a parameter of the second time window. The parameter of the first time window includes a duration, a start time, and/or an end time of the first time window. The parameter of the second time window includes a duration, a start time, and/or an end time of the second time window. It can be learned that the first time window used for monitoring the PDCCH and/or the SIB1 is associated with the second time window for responding to the SIB1 request.

In an example, the first control signalling may be separately transmitted after the first response is transmitted. In this scenario, the start time of the first time window may be later than the start time of the second time window. For example, the start time of the first time window may be the end time of the second time window, or may be any time point after the start time of the second time window.

In the foregoing example, when the first control signalling is separately transmitted, the terminal device needs to determine when to start monitoring the first control signalling. In other words, the terminal device needs to determine the configuration parameter of the first time window for monitoring the first control signalling.

In an example, the first control signalling may be carried in the first response. When the first response includes the first control signalling, the start time of the first time window may be the same as the start time of the second time window. The duration of the second time window may be less than or equal to the duration of the first time window.

In the foregoing example, when the first response includes the first control signalling, the terminal device may monitor the first control signalling in the second time window.

In some embodiments, the first time window may be further used by the terminal device to receive the SIB1. It can be learned that the terminal device may monitor the first control signalling in the first time window, and complete reception of the SIB1 based on the first control signalling obtained through monitoring.

In an example, the SIB1 in the first time window may be repeatedly transmitted, to improve reliability and meet requirements of a plurality of terminal devices. A maximum quantity of repetitions of the on-demand SIB1 may depend on a static factor, for example, a size of a first cell. For example, the SIB1 is transmitted every 160 ms, and a default repetition interval is within 160 ms. Based on a searchSpaceZero setting, the network device may use a type-0 (Type-0) PDCCH to schedule an occasion of repeated SIB1 transmission in 160 ms.

In some embodiments, the configuration parameter of the first time window may be used by the terminal device to determine a location of the first time window in time domain. For example, the configuration parameter of the first time window may be used by the terminal device to determine the start time of the first time window and the duration (duration) of the first time window. For another example, the configuration parameter of the first time window may be used by the terminal device to determine the start time and the end time of the first time window.

In an example, the duration of the first time window may be set long enough to allow a terminal device with a low signal-to-noise ratio (for example, a UE at a cell edge) to receive and combine a plurality of repeated SIB1s for successful decoding.

In an embodiment, the configuration parameter of the first time window may explicitly or implicitly indicate the start time and the duration of the first time window. For example, the configuration parameter of the first time window may include the start time and the duration of the first time window. For another example, the configuration parameter of the first time window may include a reference time point (reference time point) and an offset between the start time of the first time window and the reference time point.

In the foregoing embodiment, the reference time point may be defined based on a receiving time of the first response. For example, the reference time point may be defined by using a receiving slot, a symbol, and a frame of the first response. In other words, the reference time point is a receiving time of the first response.

In the foregoing embodiment, the reference time point may be defined based on the transmitting time (transmission time) of the first information. In other words, the reference time point is the transmitting time of the first information. There is a specific time interval between the start time of the first time window and the transmitting time of the first information, so that the terminal device receives the first response. The terminal device receives the SIB1 after receiving the first response. For example, the terminal device monitors the on-demand SIB1 in the PDCCH window only when successfully receiving the RR in the RRW after the UL-WUS transmission. Therefore, the reference time point of the first time window may be a time point after an offset time from the transmitting time of the UL-WUS.

In the foregoing embodiment, the reference time point may be defined based on the second time window. In an example, the reference time point may be the start time or the end time of the second time window. For example, the reference time point may be the start time of the second time window after UL-WUS transmission. For another example, the reference time point is defined based on the second time window, and the terminal device may further monitor scheduling information of the PDCCH in this window.

The configuration parameter of the first time window may be carried in the configuration information of the first information, the first response, and/or a MIB. In an example, the terminal device may determine the configuration parameter of the first time window based on the configuration information of the first information. In another example, after transmitting the first information, the terminal device may determine the configuration parameter of the first time window based on the first response fed back by the network device.

In some embodiments, when the configuration parameter of the first time window is carried in the configuration information of the first information or the MIB, a configuration of the first time window is a semi-static configuration. In an example, when the first information is a UL-WUS, the configuration information of the first information may be referred to as a UL-WUS configuration. The network device may implement a semi-static configuration of the parameter of the first time window by using the UL-WUS configuration, to support transmission of the OD-SIB1.

In the foregoing embodiment, the configuration parameter of the first time window is associated with at least one of the following information: the reference time point used for determining the first time window; an offset used for determining the first time window; or one or more candidate durations of the first time window.

In an example, the configuration parameter of the first time window may indicate any reference time point described above. For example, the reference time point used for determining the start time of the first time window is the transmitting time of the first information or the receiving time of the first response. In other words, the start time of the first time window is determined based on the transmitting time of the first information and/or the receiving time of the first response.

In an example, the configuration parameter of the first time window may include the offset between the start time of the first time window and the reference time point. For example, when the reference time point is the receiving time of the first response, the configuration parameter of the first time window may include a first offset between the receiving time of the first response and the start time of the first time window. For another example, when the reference time point is the transmitting time of the first information, the configuration parameter of the first time window may include a fourth offset between the transmitting time of the first information and the start time of the first time window.

In the foregoing example, the plurality of terminal devices may be configured with the same first offset or the same fourth offset. When the same first offset is used, the start time of the first time window on the terminal device side changes according to a time of successfully receiving the first response. This may be unknown to the NES cell. This is because the network device may be unable to determine the time of successfully receiving the first response by the terminal device.

In an example, the configuration parameter of the first time window may include the one or more candidate durations, and the duration of the first time window is one of the one or more candidate durations. To improve semi-static indication flexibility, the network device may indicate a plurality of candidate durations through a semi-static configuration, and the terminal device may select the duration of the first time window from the plurality of candidate durations based on other information. For example, the duration of the first time window may be predefined with a plurality of configuration values.

In an example, the configuration parameter of the first time window may include searchSpaceZero and controlResourceSetZero. For example, for a PDCCH monitoring scenario of the on-demand SIB1, the network device may provide searchSpaceZero and controlResourceSetZero of the on-demand SIB1 in the UL-WUS configuration (the configuration information of the first information).

In some embodiments, when the configuration parameter of the first time window is carried in the first response, a configuration of the first time window is a dynamic indication. For example, the first response may support searchSpaceZero and/or a dynamic indication of the start time and the duration of the first time window. In other words, information of the first response may carry a monitoring window of the on-demand SIB1. When the terminal device successfully receives the first response on a frame/slot/symbol in time domain, the first response may carry time window (first time window) information of actual on-demand SIB1 transmission.

In the foregoing embodiment, the configuration parameter of the first time window is associated with at least one of the following information: the first offset between the receiving time of the first response and the start time of the first time window; the duration of the first time window; the end time of the first time window; the start time of the second time window; or the end time of the second time window. The second time window for receiving the first response by the terminal device may be associated with the configuration parameter of the first time window.

In an example, because the terminal device cannot determine a time at which the first response is received, a time reference point of a dynamic indication is usually the receiving time of the first response. The configuration parameter of the first time window may include the first offset. For example, the network device may indicate, by using a plurality of responses, first offsets respectively corresponding to a plurality of terminal devices, to align first time windows of the plurality of terminal devices.

In an example, in a dynamic indication configuration manner, the configuration parameter of the first time window may directly indicate the duration of the first time window. For example, a first response received by the terminal device by using an LP-WUR may indicate the start time and the duration of the first time window.

In an example, in a dynamic indication configuration manner, the configuration parameter of the first time window may include the end time of the first time window.

In some embodiments, a part of parameters in the configuration parameter of the first time window may be fixed, and the other part of parameters may be configurable. For example, when the configuration parameter of the first time window is carried in the UL-WUS configuration, the duration of the first time window may be indicated by the UL-WUS configuration, and an offset of the start time of the first time window is fixed. A configurable duration may cover a target quantity of repeated SIB1 transmissions based on a first cell size. A fixed offset of the start time may be predefined or preconfigured by using a higher layer or a protocol.

In the foregoing embodiment, the network device may process a delay based on the PDSCH for transmitting the first response.

In some embodiments, a format of the first response or the configuration information of the first information needs to be redesigned to support a semi-static or fixed-parameter PDCCH window. In an example, when the first information is transmitted by using a random access request, a group of parameters such as (searchSpaceZero, the start offset of the PDCCH window, and the duration of the PDCCH window) may be used in the first response triggered by the first information transmitted in different PRACH scenarios.

In some embodiments, by indicating a transmitting time of the SIB1, the first control signalling may indicate the terminal device to receive the SIB1. The transmitting time of the SIB1 is usually scheduled by a cell. After determining the transmitting time of the SIB1, the network device may notify the terminal device by using the first control signalling. In an example, the network device may make a plan based on a specific time interval (periodicity) or according to coverage requirements of different SSBs. In an example, the network device may schedule SIB1 transmission based on a quantity of terminal devices that request the SIB1 within a period of time or a location of the terminal device. The period of time may be a specific time period described above.

In some embodiments, the transmitting time of the SIB1 may include one or more of the following parameters: a parameter of a time window used for transmitting the SIB1, one or more SIB1 transmission occasions, one or more SIB1 monitoring occasions (SIB1 MO), or a SIB1 transmission periodicity.

In an example, a plurality of SIB1 transmission occasions respectively correspond to different SSBs to meet requests of different areas. For example, a plurality of SIB1 transmission occasions may periodically correspond to a plurality of SSBs transmitted by the network device, for example, an SSB #0 and an SSB #1.

In the foregoing example, when a plurality of terminal devices including the terminal device request the OD-SIB1, request times may be different. First time windows of different terminal devices may overlap or partially overlap. Within an overlapping time interval, the NES cell may transmit, to different terminal devices, SIB1s associated with different SSBs.

In some embodiments, one or more SIB1 transmission occasions may be configured in the time window used for transmitting the SIB1 by the network device. The SIB1 transmission occasion means an occasion of transmitting the SIB1 by the network device, or an occasion of receiving the SIB1 by the terminal device.

Optionally, the plurality of SIB1 transmission occasions in the time window used for transmitting the SIB1 may be periodic or may be aperiodic.

In an example, the time window used for transmitting the SIB1 belongs to the first time window, or is the first time window (SIB1_{TDW1}). When the time window used for transmitting the SIB1 belongs to the first time window, the start point of the first time window is an indicated start point (indicated start point).

In an example, after the terminal device transmits the UL-WUS, a delay usually exists between an actual transmission start point of the SIB1 time window (actually starting time of SIB1 monitoring window) and an end time of the RRW, to ensure that the terminal device has enough time to decode the RR and is ready to monitor the SIB1. The cell may schedule a plurality of SIB1s in different SSB ranges to meet requirements of different terminal devices.

In the foregoing example, an actual transmission time of the SIB1 is usually not completely consistent with the start time of the first time window. Instead, a specific delay exists. A cell side cannot predict a specific response received by the terminal device. Therefore, responses need to be transmitted at a plurality of time points, and the on-demand SIB1 is transmitted at an appropriate instant after the response according to a scheduling plan. The transmitting time of the on-demand SIB1 must cover a possible monitoring occasion of the terminal device after the second time window, to ensure that the terminal device has an opportunity to receive the SIB1.

It should be noted that when the SIB1 is transmitted after the second time window, a processing time after the terminal device receives the first response needs to be reserved (for example, a time required for decoding the first response, calculating a subsequent action, and so on). In addition, the first cell may need to transmit the SIB1 on different SSB resources. Therefore, a specific transmitting time of the SIB1 may be a plurality of discrete time points.

In some embodiments, the network device may set two time windows: the first time window and a third time window (SIB1_{TDW3}). The first time window is a time window in which the terminal device can monitor the PDCCH, and the third time window is a time window for actual SIB1 transmission described above. The first time window and the third time window may be configured by using the configuration information of the first information, the first response, or the MIB.

In an example, the first time window may include the third time window. In other words, the first time window may be greater than the third time window, and the third time window for actual SIB1 transmission is used as a part of the first time window. After the start time of the first time window (a start time point of SIB1_{TDW1}), all terminal devices that successfully receive responses need to wait for the third time window, and a waiting duration is (SIB1_{TDW1}−SIB1_{TDW3}).

In an example, the start time of the third time window may also be a receiving time of successfully receiving the first response and used as a reference time point. For example, the terminal device may shift several subframes/slots backward to monitor the PDCCH and the SIB1. In the third time window, the network device needs to make more terminal devices receive the on-demand SIB1. For example, the network device may indicate, by using a plurality of responses, first offsets corresponding to a plurality of terminal devices, to align third time windows of the plurality of terminal devices and uniformly schedule windows of SIB1s.

In some embodiments, the first time window may include the third time window and/or a fourth time window (SIB1_{TDW4}) for SIB1 transmission. The third time window may include one or more SIB1 transmission occasions. The fourth time window may include one or more candidate SIB1 transmission occasions. It can be learned that SIB1 transmission can be implemented in the third time window, and SIB1 transmission can be implemented in the fourth time window provided that the fourth time window needs to meet a specific condition.

In an example, a scenario in which the first time window includes only the third time window is described as the foregoing. In some scenarios, the first time window may further include only the fourth time window. In other words, the first time window is configured with only one or more candidate SIB1 transmission occasions, and does not include periodic a plurality of SIB1 transmission occasions. In some scenarios, the first time window includes the third time window and the fourth time window. Details are described below.

Optionally, when the first time window includes the third time window and the fourth time window, the network device may configure and enable only the third time window, or may configure and enable both the third time window and the fourth time window, or may configure and enable only the fourth time window.

Optionally, the third time window and the fourth time window may also be dynamically adjusted. For example, the third time window and the fourth time window may be adjusted based on a cell load change. For another example, a transmission occasion interval between the third time window and the fourth time window is added at a low load to save resources.

In an example, a plurality of SIB1 transmission occasions in the third time window are configured according to a specific periodicity. In other words, on-demand SIB1 transmission in the third time window is periodic. A SIB1 transmission occasion may also be referred to as a SIB1 scheduling occasion and a SIB1 scheduling time point.

In an example, the fourth time window is a candidate time window for scheduling SIB1, and may also be referred to as a SIB1 candidate time window. The candidate SIB1 transmission occasion in the SIB1 candidate time window may be a group of cell-predefined time points that may be used for on-demand SIB1 transmission. The plurality of candidate SIB1 transmission occasions in the fourth time window may be distributed according to a periodicity or scheduling logic. For example, the plurality of candidate SIB1 transmission occasions in the fourth time window may be periodic or aperiodic.

In an example, in the first time window, the fourth time window is earlier than the third time window. For example, a start time of the fourth time window is earlier than a start time of the third time window, and/or an end time of the fourth time window is not later than the start time of the third time window. When the fourth time window is earlier than the third time window, one or more predefined candidate SIB1 transmission occasions may meet a requirement of a specific terminal device.

In an example, in the first time window, the fourth time window is later than the third time window. A start time of the third time window is earlier than a start time of the fourth time window, and/or an end time of the third time window is not later than the start time of the fourth time window. When the fourth time window is later than the third time window, one or more predefined candidate SIB1 transmission occasions may be used to avoid a case in which a part of terminal devices does not receive the SIB1 in time.

In the foregoing embodiment, the third time window is used as a time window for actual on-demand SIB1 transmission, that is, a window for actual on-demand SIB1 transmission performed by a network, to ensure that a terminal device that meets a condition can receive a valid SIB1 within a specified time window. The fourth time window may allow some specific terminal devices to receive the on-demand SIB1.

In some embodiments, the candidate SIB1 transmission occasion is a transmission occasion predefined by the network device. After the candidate SIB1 transmission occasion is activated, the candidate SIB1 transmission occasion becomes the SIB1 transmission occasion. When the candidate SIB1 transmission occasion is not activated, the SIB1 is not transmitted in the occasion.

In an example, one or more candidate SIB1 transmission occasions include a first candidate SIB1 transmission occasion. Whether the first candidate SIB1 transmission occasion is activated is determined based on a first activation condition. The first activation condition may be related to an event, or may be a specific scenario.

In the foregoing example, some candidate SIB1 transmission occasions in the fourth time window may be activated only when specific conditions are met or may be triggered based on events. For example, the specific condition is that a request transmitted by the terminal device or a channel status meets a requirement. For these candidate SIB1 transmission occasions, a conditional function may be introduced. If the conditions are met or triggering is performed by the events, the on-demand SIB1 is transmitted in these transmission occasions.

In the foregoing example, the first activation condition is related to a service priority and/or a service requirement of the terminal device. In the first candidate SIB1 transmission occasion, if no terminal device meets a condition of decoding or receiving the on-demand SIB1, the cell chooses not to activate the first candidate SIB1 transmission occasion, that is, does not transmit the on-demand SIB1 in the transmission occasion. Optionally, for an unactivated candidate SIB1 transmission occasion in the fourth time window, the NES cell may be allocated to a service with a higher priority for occupation.

In an example, a quantity of activated candidate SIB1 transmission occasions in a plurality of candidate SIB1 transmission occasions is further determined based on a quantity of a plurality of terminal devices. In an example, when there are a large quantity of terminal devices that transmit UL-WUSs in the first cell, the first cell needs to allocate resources according to a requirement of each terminal device. This may affect a SIB1 transmission occasion configuration. For example, the plurality of terminal devices may monitor the SIB1 in the candidate SIB1 transmission occasion. The network needs to dynamically adjust allocation of these transmission occasions according to a load. Under a high load condition, the first cell may intensively allocate the candidate SIB1 transmission occasion (that is, shorten an interval between candidate time points). Under a low load condition, the first cell may reduce a quantity of candidate SIB1 transmission occasions and elongate a transmission interval, to save resources.

In an example, the quantity of candidate SIB1 transmission occasions may be predefined. Under the high load condition, all candidate SIB1 transmission occasions are used for actual SIB1 transmission. In a low-load case, the cell transmits the SIB1 only at few transmission occasions, and an unused transmission occasion is reserved.

In an example, a quantity of candidate SIB1 transmission occasions included in the fourth time window is determined based on a network load of a current time period. When the plurality of candidate SIB1 transmission occasions in the fourth time window are distributed based on the first periodicity, the first periodicity of the current time period is the current first periodicity. The current first periodicity is related to one or more of the following information: an initial value of the first periodicity; a maximum load of a first cell in which the terminal device is located; a load threshold of a first cell in which the terminal device is located; or a current load of a first cell in which the terminal device is located.

In an example, the initial value of the first periodicity is a fixed interval periodicity of a candidate SIB1 transmission occasion.

In an example, the maximum load of the first cell may be a maximum quantity of terminal devices in the first cell (for example, a cell capacity).

In an example, the load threshold of the first cell may be a threshold for load adjustment performed by the first cell.

In an example, the current load of the first cell may be a quantity of terminal devices that request the SIB1 in the current time period.

For example, the candidate periodicity may be represented as

$$T {1}^{′} = T 1 * \frac{{N}_{max}}{N} ,$$

where T1 represents the initial value of the first periodicity, Nₘₐₓ represents the maximum load or the load threshold of the first cell, and N represents the current load of the first cell.

Optionally, T1′ is an adjusted periodicity, that is, a load dynamic adjustment interval. When N increases, T1′ decreases, and more SIB1s are needed. When N decreases, T1′ increases, and fewer SIB1s are needed. If there are a large quantity of terminal devices that transmit UL-WUSs in a period of time, the NES cell needs to provide reliable responses (and SIB1s) for these terminal devices. Therefore, a SIB1 transmission occasion needs to be added. If there are few terminal devices that transmit UL-WUSs within a period of time, the cell needs to transmit the SIB1 at only few time points, thereby reducing activated candidate SIB1 transmission occasions.

In some embodiments, possibility that the plurality of candidate SIB1 transmission occasions in the fourth time window are activated may be estimated by probability. It is assumed that P is probability that a candidate SIB1 transmission occasion is actually used for transmitting the SIB1. In this case, P=min {1, N/Nₘₐₓ}.

Optionally, P approaching 1 indicates a high load, all candidate time points are basically padded. P approaching 0 indicates a low load. The SIB1 is not transmitted at most candidate points. By setting different thresholds of P, the candidate time point may be dynamically adjusted to transmit the on-demand SIB1.

In some embodiments, the fourth time window may be further used by the network device to monitor the SIB1 requests of the plurality of terminal devices.

In some embodiments, when the first response includes the first control signalling, the first control signalling may further indicate a second offset between the receiving time of the first response and a first SIB1 transmission occasion. In other words, the first control signalling may directly indicate the terminal device to receive the SIB1 in the first SIB1 transmission occasion. The first SIB1 transmission occasion is a SIB1 transmission occasion closest to the receiving time of the first response.

In the foregoing embodiment, the plurality of terminal devices may correspond to the same second offset, or may correspond to different second offsets. For example, at least two second offsets of a plurality of second offsets corresponding to the plurality of terminal devices are different.

In some embodiments, when the first response does not include the first control signalling, the first response may indicate a third offset between the receiving time of the first response and a first monitoring occasion. The first monitoring occasion is an occasion in which the terminal device monitors the first control signalling in the first time window. The first monitoring occasion may alternatively be a dedicated monitoring occasion configured by the network device for the terminal device.

In an example, the first monitoring occasion may be one of a plurality of PDCCH monitoring occasions.

In the foregoing embodiment, the plurality of terminal devices may correspond to the same third offset, or may correspond to different third offsets. For example, when the plurality of terminal devices correspond to the same third offset, all terminal devices in the same cell share the same scheduling parameter. For another example, at least two third offsets of a plurality of third offsets corresponding to the plurality of terminal devices are different.

In some embodiments, the plurality of terminal devices including the terminal device may correspond to different third offsets. For example, PDCCH offsets corresponding to all the terminal devices are different. A third offset corresponding to any terminal device in the plurality of terminal devices is determined based on at least one of the following information: a location of the any terminal device; a service type of the any terminal device; a resource of the any terminal device; or a network configuration of a first cell in which the plurality of terminal devices are located.

In an example, terminal devices in different locations have different requirements for SIB1 scheduling. For example, the terminal devices in different locations affect reference time points corresponding to the UL-WUSs and the RRs due to different path losses and propagation delays. If a physical location of a terminal device 1 is close to a physical location of a terminal device 2, and a path loss difference and a propagation delay difference between the terminal device 1 and the terminal device 2 are relatively small, third offsets may be set to the same value. If a physical location of a terminal device 1 is distant from a physical location of a terminal device 2, third offsets need to be separately configured, to compensate for a propagation delay difference.

In an example, different terminal devices may belong to different service types (for example, eMBB, URLLC, and eMTC). Different service types have different scheduling priorities and different resource allocation. For a terminal device with a high priority (for example, a URLLC user), a third offset may be shorter, and a request response and an on-demand SIB1 transmission arrangement may also be earlier.

In an example, transmission resources allocated to different terminal devices may be different, and the transmission resources affect a scheduling parameter configuration.

In some embodiments, when the terminal device does not detect the first control signalling/SIB1 in the first time window, a retransmission request may be transmitted. For example, if the terminal device does not detect the PDCCH in the first time window, the terminal device may request the network device to perform retransmission. For another example, in the NES cell, after transmitting the UL-WUS signal, the terminal device listens to/monitors, in the first time window, the OD-SIB1 scheduled by the PDCCH. If the OD-SIB1 of the PDCCH is not received in the first time window, it is considered that the UL-WUS fails to be transmitted this time, and then retransmission is requested.

In an example, the terminal device may request retransmission by transmitting a negative acknowledgement (negative acknowledgement, NACK).

In an example, the network device may determine a transmission time sequence of the RR and the SIB1/PDCCH based on whether the terminal device feeds back an ACK/a NACK. If the terminal device fails to receive the response in the RRW or the response does not include PDCCH window information for scheduling the SIB1, and a semi-static configuration does not include the PDCCH window information, retransmission on a cell side may be triggered.

With reference to FIG. 5 to FIG. 7, the foregoing describes a method embodiment in which the terminal device transmits the first information and monitors the first control signalling by using the configuration information of the first information or the first response. The terminal device may transmit a plurality of pieces of information including the first information, to ensure that the network device receives the SIB1 request. The network device may transmit one or more responses based on one piece of information, and then perform SIB1 transmission after the response.

For ease of understanding, with reference to FIG. 8 and FIG. 9, the following describes an example of SIB1 transmission performed by a network device (for example, a gNB) after a response is transmitted. FIG. 8 is that the network device transmits a response (RR) and a SIB1 based on one terminal device. FIG. 9 is that the network device transmits responses and SIB1s based on a plurality of terminal devices. It should be noted that when the response transmitted by the network device does not include the PDCCH, the SIB1 in FIG. 8 and that in FIG. 9 may also be replaced with control signalling (PDCCH).

FIG. 8 is described by using an example in which a UL-WUS is transmitted based on power ramping, and is also applicable in a case of a constant power. As shown in FIG. 8, three UL-WUSs transmitted by the terminal device are respectively a WUS #1, a WUS #2, and a WUS #3. There is one RRW after each UL-WUS, that is, a second time window. The RRW after the WUS #3 is used as an example. The network device may transmit a plurality of RRs in the RRW, for example, an RR #1 to an RR #x.

With reference to FIG. 8, in the RRW, the RR #1 may be the first received response when the RRW starts, and the RR #x is the last received response after the RRW starts. A gNB time window is used for transmitting a SIB1 A start time of the gNB time window may be determined based on a time point at which the terminal device receives the RR #1 and an offset t1, and an end time may be determined based on a receiving time of the RR #x, an offset tx, and a SIB1 transmission time period.

Optionally, when the SIB1 is a PDCCH, the offset in FIG. 8 may be the foregoing third offset. Herein, t1 may be equal to tx, that is, a plurality of third offsets are equal; or t1 may not be equal to tx, that is, at least two offsets of a plurality of third offsets are not equal.

FIG. 9 is described by using x terminal devices including a terminal device as an example. The x terminal devices are respectively a UE 1 and a UE 2 to a UE x. The x terminal devices may respectively transmit x WUSs, and monitor, within an RRW, an RR transmitted by the network device. After receiving the RR, the terminal device may receive a SIB1 or a PDCCH based on an offset tx. A start time of the gNB time window may be determined based on a receiving time of a transmitted RR #1 and an offset t1, and an end time may be determined based on a receiving time of an RR #x, the offset tx, and a SIB1 transmission time period.

Optionally, when the RR in FIG. 9 includes first control signalling, t1 or tx may represent the foregoing second offset. A plurality of second offsets of the plurality of terminal devices are usually different. However, in a case of the same RR transmission periodicity and the same SIB1, the plurality of second offsets are the same.

Optionally, when the RR in FIG. 9 does not include first control signalling, t1 or tx may represent the foregoing third offset. A plurality of third offsets of the plurality of terminal devices may be different or the same.

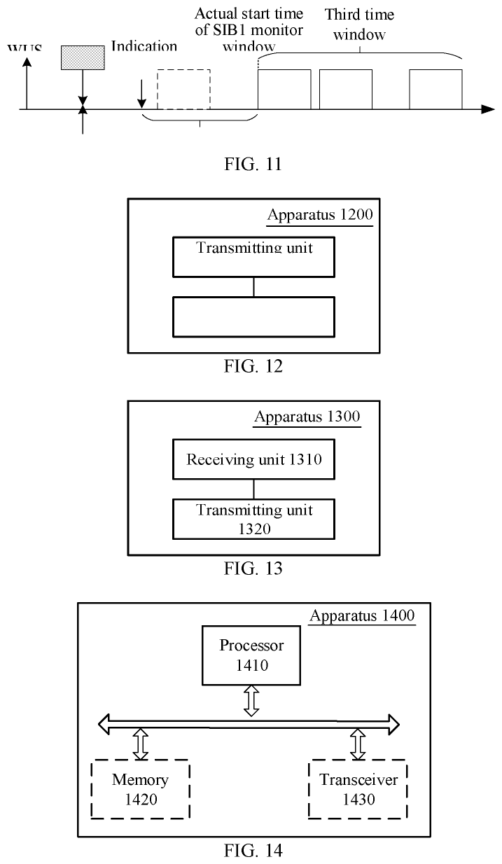

With reference to FIG. 8 and FIG. 9, the foregoing describes an example in which a network device transmits a first response, first control signalling, and/or a SIB1 based on a WUS. The following describes an example of the foregoing plurality of time windows and the plurality of offsets with reference to FIG. 10 and FIG. 11.

To describe a part of time windows and offsets above, the following definition is provided: T_{UL-WUS} represents a start time point of UL-WUS transmission, that is, a transmitting time of first information. T_{RR_ref} represents a reference time point (also referred to as an RR reference time point) corresponding to a first response, that is, a start time of a second time window. ΔT_{RRW} represents a duration of the second time window. T_{SIB1_trans} represents an actual transmitting time point of an SIB1. ΔT_{offset_RR} represents an offset between a UL-WUS and the reference time point corresponding to the first response, that is, a fifth offset. ΔT_{offset_SIB1} represents an offset between the reference time point corresponding to the first response and the actual transmitting time point of the SIB1, that is, a second offset.

Based on the related definition in the foregoing example, the reference time point corresponding to the first response may be represented as: T_{RR_ref}=T_{UL-WUS}+T_{offset_RR}. An end time point of the second time window may be represented as: T_{RR_end}=T_{RR_ref}+ΔT_{RRW}. A general formula of the actual transmitting time point of the SIB1 may be represented as:

T_{SIB1_trans}=T_{RR_ref}+ΔT_{RRW}+T_{offset_SIB1}.

FIG. 10 is a schematic diagram of setting a first time window and a third time window by a network device. As shown in FIG. 10, after a terminal device transmits a WUS, the network device may transmit an RR at a reference time point or in a second time window related to a reference time point. Based on a time point corresponding to the WUS or the RR, the terminal device may determine an indicated start time of a first time window. A start time of the third time window used for periodically transmitting a SIB1 is an actual start time of a SIB1 monitoring window. It may be learned from FIG. 10 that the start time of the third time window is later than the start time of the first time window, and an end time of the third time window is the same as an end time of the first time window. A length of the third time window is less than a length of the first time window.

Still with reference to FIG. 10, the third time window includes a plurality of SIB1 transmission occasions. A plurality of SIB1 in the third time window periodically correspond to SSBs transmitted by the network device, for example, an SSB #0 and an SSB #1, to meet SIB1 requests of terminal devices in different areas.

FIG. 11 is a schematic diagram in which a first time window includes a third time window and a fourth time window. In comparison with FIG. 10, the fourth time window includes one or more candidate SIB1 transmission occasions, and a dashed line may indicate a candidate SIB1 transmission occasion.

It can be learned from FIG. 10 and FIG. 11 that there is a specific relationship and a specific time offset between an RR reference time point and an actual transmitting time point of a SIB1.

The foregoing describes the method embodiments of the present application in detail with reference to FIG. 1 to FIG. 11. The following describes in detail the apparatus embodiments of the present application with reference to FIG. 12 to FIG. 14. It should be understood that the description of the apparatus embodiments corresponds to the description of the method embodiments. Therefore, for parts that are not described in detail, reference may be made to the foregoing method embodiments.

FIG. 12 is a schematic block diagram of an apparatus for wireless communication according to an embodiment of the present application. The apparatus 1200 may be any terminal device described above. The apparatus 1200 shown in FIG. 12 includes a transmitting unit 1210 and a receiving unit 1220.

The transmitting unit 1210 may be configured to transmit first information, where the first information is used to request a network device to transmit a SIB1.

The receiving unit 1220 is configured to monitor first control signalling in a first time window, where the first control signalling is used to instruct the terminal device to receive the SIB1, a configuration parameter of the first time window is carried in configuration information of the first information and/or a first response, and the first response is feedback of the network device for the first information.

Optionally, the first response is associated with a second time window, and a parameter of the first time window is determined based on a parameter of the second time window.

Optionally, the first response belongs to a plurality of responses transmitted by the network device in the second time window; and the plurality of responses are used by the network device to feed back a plurality of SIB1 requests transmitted by the terminal device, or the plurality of responses are used by the network device to feed back a plurality of SIB1 requests transmitted by a plurality of terminal devices including the terminal device.

Optionally, the first time window includes a third time window and/or a fourth time window, the third time window includes one or more SIB1 transmission occasions, and the fourth time window includes one or more candidate SIB1 transmission occasions.

Optionally, a start time of the fourth time window is earlier than a start time of the third time window, and/or an end time of the fourth time window is not later than the start time of the third time window.

Optionally, the one or more candidate SIB1 transmission occasions include a first candidate SIB1 transmission occasion, whether the first candidate SIB1 transmission occasion is activated is determined according to a first activation condition, and the first activation condition is related to a service priority and/or a service requirement of the terminal device.

Optionally, the network device corresponds to a first cell, the terminal device is one of a plurality of terminal devices that request a SIB1 in the first cell, and a quantity of activated candidate SIB1 transmission occasions in the plurality of candidate SIB1 transmission occasions is determined based on a quantity of the plurality of terminal devices.

Optionally, a quantity of candidate SIB1 transmission occasions included in the fourth time window is preconfigured, or a quantity of candidate SIB1 transmission occasions included in the fourth time window is determined based on a network load in a current time period.

Optionally, the plurality of candidate SIB1 transmission occasions in the fourth time window are distributed based on a first periodicity, the current time period corresponds to a current first periodicity, and the current first periodicity is related to one or more of the following information: an initial value of the first periodicity; a maximum load of a first cell in which the terminal device is located; a load threshold of a first cell in which the terminal device is located; or a current load of a first cell in which the terminal device is located.

Optionally, the current first periodicity is

$$T {1}^{′} = T 1 * \frac{{N}_{max}}{N} ,$$

where T1 represents the initial value, Nₘₐₓ represents the maximum load or the load threshold, and N represents the current load.

Optionally, the configuration parameter of the first time window is carried in the configuration information of the first information, and the configuration parameter of the first time window is associated with at least one of the following information: a reference time point used for determining the first time window; an offset used for determining the first time window; or one or more candidate durations of the first time window.

Optionally, the reference time point includes one of the following: a transmitting time of the first information; a receiving time of the first response; or a start time or an end time of a second time window.

Optionally, the configuration parameter of the first time window is carried in the first response, and the configuration parameter of the first time window is associated with at least one of the following information: a first offset between a receiving time of the first response and a start time of the first time window; a duration of the first time window; an end time of the first time window; a start time of a second time window; or an end time of the second time window.

Optionally, the first response includes the first control signalling, the first control signalling is used to indicate a second offset between a receiving time of the first response and a first SIB1 transmission occasion, and the first SIB1 transmission occasion is a SIB1 transmission occasion that is closest to the receiving time of the first response in the first time window.

Optionally, the first response does not include the first control signalling, the first response is used to indicate a third offset between a receiving time of the first response and a first monitoring occasion, and the first monitoring occasion is an occasion that is used by the terminal device to monitor the first control signalling in the first time window.

Optionally, the terminal device is one of a plurality of terminal devices, and a third offset corresponding to any terminal device in the plurality of terminal devices is determined based on at least one of following information: a location of the any terminal device; a service type of the any terminal device; a resource of the any terminal device; or a network configuration of a first cell in which the plurality of terminal devices are located.

Optionally, the transmitting unit 1210 is further configured to: after transmitting the first information, transmit second information, where the second information is further used to request the SIB1, where a transmit power of the second information is greater than or equal to a transmit power of the first information.

Optionally, the first information and the second information belong to a plurality of pieces of information in which the terminal device requests the SIB1, and a transmission periodicity of at least two pieces of information whose transmitting times are later in the plurality of pieces of information is less than a transmission periodicity of at least two pieces of information whose transmitting times are earlier.

FIG. 13 is a schematic block diagram of another apparatus for wireless communication according to an embodiment of the present application. The apparatus 1300 may be any network device described above. The apparatus 1300 shown in FIG. 13 includes a receiving unit 1310 and a transmitting unit 1320.

The receiving unit 1310 may be configured to receive first information, where the first information is used by a terminal device to request a SIB1.

The transmitting unit 1320 may be configured to transmit first control signalling in a first time window, where the first control signalling is used to instruct the terminal device to receive the SIB1, a configuration parameter of the first time window is carried in configuration information of the first information and/or a first response, and the first response is feedback of the network device for the first information.

Optionally, the first response is associated with a second time window, and a parameter of the first time window is determined based on a parameter of the second time window.

Optionally, the first response belongs to a plurality of responses transmitted by the network device in the second time window; and the plurality of responses are used by the network device to feed back a plurality of SIB1 requests transmitted by the terminal device, or the plurality of responses are used by the network device to feed back a plurality of SIB1 requests transmitted by a plurality of terminal devices including the terminal device.

Optionally, the first time window includes a third time window and/or a fourth time window, the third time window includes one or more SIB1 transmission occasions, and the fourth time window includes one or more candidate SIB1 transmission occasions.

Optionally, a start time of the third time window is earlier than a start time of the the fourth time window, and/or an end time of the third time window is not later than the start time of the fourth time window.

Optionally, the one or more candidate SIB1 transmission occasions include a first candidate SIB1 transmission occasion, whether the first candidate SIB1 transmission occasion is activated is determined according to a first activation condition, and the first activation condition is related to a service priority and/or a service requirement of the terminal device.

Optionally, the network device corresponds to a first cell, the terminal device is one of a plurality of terminal devices that request a SIB1 in the first cell, and a quantity of activated candidate SIB1 transmission occasions in the plurality of candidate SIB1 transmission occasions is determined based on a quantity of the plurality of terminal devices.

Optionally, a quantity of candidate SIB1 transmission occasions included in the fourth time window is preconfigured, or a quantity of candidate SIB1 transmission occasions included in the fourth time window is determined based on a network load in a current time period.

Optionally, the plurality of candidate SIB1 transmission occasions in the fourth time window are distributed based on a first periodicity, the current time period corresponds to a current first periodicity, and the current first periodicity is related to one or more of the following information: an initial value of the first periodicity; a maximum load of a first cell in which the terminal device is located; a load threshold of a first cell in which the terminal device is located; or a current load of a first cell in which the terminal device is located.

Optionally, the current first periodicity is

$$T {1}^{′} = T 1 * \frac{{N}_{max}}{N} ,$$

where T1 represents the initial value, Nₘₐₓ represents the maximum load or the load threshold, and N represents the current load.

Optionally, the configuration parameter of the first time window is carried in the configuration information of the first information, and the configuration parameter of the first time window is associated with at least one of the following information: a reference time point used for determining the first time window; an offset used for determining the first time window; or one or more candidate durations of the first time window.

Optionally, the reference time point includes one of the following: a transmitting time of the first information; a receiving time of the first response; or a start time or an end time of a second time window.

Optionally, the configuration parameter of the first time window is carried in the first response, and the configuration parameter of the first time window is associated with at least one of the following information: a first offset between a receiving time of the first response and a start time of the first time window; a duration of the first time window; an end time of the first time window; a start time of a second time window; or an end time of the second time window.

Optionally, the first response includes the first control signalling, the first control signalling is used to indicate a second offset between a receiving time of the first response and a first SIB1 transmission occasion, and the first SIB1 transmission occasion is a SIB1 transmission occasion that is closest to the receiving time of the first response in the first time window.

Optionally, the first response does not include the first control signalling, the first response is used to indicate a third offset between a receiving time of the first response and a first monitoring occasion, and the first monitoring occasion is an occasion that is used by the terminal device to monitor the first control signalling in the first time window.

Optionally, the terminal device is one of a plurality of terminal devices, and a third offset corresponding to any terminal device in the plurality of terminal devices is determined based on at least one of following information: a location of the any terminal device; a service type of the any terminal device; a resource of the any terminal device; or a network configuration of a first cell in which the plurality of terminal devices are located.

Optionally, the receiving unit 1310 is further configured to: after receiving the first information, receive second information, where the second information is further used to request the SIB1, where a transmit power of the second information is greater than or equal to a transmit power of the first information.

Optionally, the first information and the second information belong to a plurality of pieces of information in which the terminal device requests the SIB1, and a transmission periodicity of at least two pieces of information whose transmitting times are later in the plurality of pieces of information is less than a transmission periodicity of at least two pieces of information whose transmitting times are earlier.

FIG. 14 is a schematic structural diagram of a communications apparatus according to an embodiment of the present application. Dashed lines in FIG. 14 indicate that a unit or module is optional. The apparatus 1400 may be configured to implement the methods described in the foregoing method embodiments. The apparatus 1400 may be a chip, a terminal device, or a network device.

The apparatus 1400 may include one or more processors 1410. The processor 1410 may support the apparatus 1400 in implementing the methods described in the foregoing method embodiments. The processor 1410 may be a general-purpose processor or a dedicated processor. For example, the processor may be a central processing unit (central processing unit, CPU). Alternatively, the processor may be another general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1400 may further include one or more memories 1420. The memory 1420 stores a program, and the program may be executed by the processor 1410, so that the processor 1410 performs the method described in the foregoing method embodiment. The memory 1420 may be separate from or integrated into the processor 1410.

The apparatus 1400 may further include a transceiver 1430. The processor 1410 may communicate with another device or chip by using the transceiver 1430. For example, the processor 1410 may transmit data to and receive data from another device or chip by using the transceiver 1430.

An embodiment of the present application further provides a computer-readable storage medium for storing a program. The computer-readable storage medium may be applied to the terminal device or the network device provided in embodiments of the present application, and the program causes a computer to perform the method performed by the terminal device or the network device in various embodiments of the present application.

The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

An embodiment of the present application further provides a computer program product. The computer program product includes a program. The computer program product may be applied to the terminal device or the network device provided in embodiments of the present application, and the program causes a computer to perform the method performed by the terminal device or the network device in various embodiments of the present application.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner.

An embodiment of the present application further provides a computer program. The computer program may be applied to the terminal device or the network device provided in embodiments of the present application, and the computer program causes a computer to perform the method to be perform by the terminal device or the network device in embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “predefining” or “preconfiguring” can be implemented by prestoring corresponding codes, tables, or other forms that may be used to indicate related information in devices (for example, including a terminal device and a network device). A specific implementation thereof is not limited in the present application. For example, being predefined may refer to being defined in a protocol.

In embodiments of the present application, the “protocol” may indicate a standard protocol in the communication field, and may include, for example, an LTE protocol, an NR protocol, and a related protocol applied to a future communications system. This is not limited in the present application.

In embodiments of the present application, determining B based on A does not mean determining B based on only A, but instead B may be determined based on A and/or other information. In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, comprising:
transmitting, by a terminal device in a network energy saving (NES) cell, first information, wherein the first information comprises a request for a network device to transmit an on demand system information block (OD-SIB1); and
monitoring, by the terminal device, first control signalling in a first time window, wherein the first control signalling indicates the terminal device to receive the OD-SIB1, a configuration parameter of the first time window is carried in configuration information of at least one of the first information or a first response, and the first response is feedback for the first information.

2. The method according to claim 1, wherein the first response is associated with a second time window, and a parameter of the first time window is determined based on a parameter of the second time window.

3. The method according to claim 2, wherein the first response belongs to a plurality of responses transmitted by the network device in the second time window; and the plurality of responses are feed back responses for a plurality of OD-SIB1 requests from one or more terminal devices including the terminal device.

4. The method according to claim 1, wherein the first time window comprises at lest one of a third time window or a fourth time window, the third time window comprises one or more OD-SIB1 transmission occasions, and the fourth time window comprises one or more candidate OD-SIB1 transmission occasions.

5. The method according to claim 4, wherein a start time of the fourth time window is earlier than a start time of the third time window, or an end time of the fourth time window is not later than the start time of the third time window.

6. The method according to claim 4, wherein the one or more candidate OD-SIB1 transmission occasions comprise a first candidate OD-SIB1 transmission occasion, whether the first candidate OD-SIB1 transmission occasion is activated is determined according to a first activation condition, and the first activation condition is related to at least one of a service priority or a service requirement of the terminal device.

7. The method according to claim 4, wherein the network device corresponds to a first cell, the terminal device is one of a plurality of terminal devices that requests an OD-SIB1 in the first cell, and a quantity of activated candidate OD-SIB1 transmission occasions in a plurality of candidate OD-SIB1 transmission occasions is determined based on a quantity of the plurality of terminal devices.

8. The method according to claim 4, wherein a quantity of candidate OD-SIB1 transmission occasions comprised in the fourth time window is preconfigured, or a quantity of candidate OD-SIB1 transmission occasions comprised in the fourth time window is determined based on a network load in a current time period.

9. The method according to claim 8, wherein a plurality of candidate OD-SIB1 transmission occasions in the fourth time window are distributed based on a first periodicity, the current time period corresponds to a current first periodicity, and the current first periodicity is related to one or more of following information:
an initial value of the first periodicity;
a maximum load of a first cell in which the terminal device is located;
a load threshold of a first cell in which the terminal device is located; or
a current load of a first cell in which the terminal device is located.

10. The method according to claim 9, wherein the current first periodicity is
$$T {1}^{′} = T 1 * \frac{{N}_{max}}{N}$$
wherein T1 represents the initial value, Nₘₐₓ represents the maximum load or the load threshold, and N represents the current load.

11. The method according to claim 1, wherein the configuration parameter of the first time window is carried in the configuration information of the first information, and the configuration parameter of the first time window is associated with at least one of following information:
a reference time point for determining the first time window;
an offset for determining the first time window; or
one or more candidate durations of the first time window.

12. The method according to claim 11, wherein the reference time point comprises one of following:
a transmitting time of the first information;
a receiving time of the first response; or
a start time or an end time of a second time window.

13. The method according to claim 1, wherein the configuration parameter of the first time window is carried in the first response, and the configuration parameter of the first time window is associated with at least one of following information:
a first offset between a receiving time of the first response and a start time of the first time window;
a duration of the first time window;
an end time of the first time window;
a start time of a second time window; or
an end time of the second time window.

14. The method according to claim 1, wherein the first response comprises the first control signalling, the first control signalling indicates a second offset between a receiving time of the first response and a first OD-SIB1 transmission occasion, and the first OD-SIB1 transmission occasion is an OD-SIB1 transmission occasion that is closest to the receiving time of the first response in the first time window.

15. The method according to claim 1, wherein the first response does not comprise the first control signalling, the first response is used to indicate a third offset between a receiving time of the first response and a first monitoring occasion, and the first monitoring occasion is an occasion that is used by the terminal device to monitor the first control signalling in the first time window.

16. The method according to claim 15, wherein the terminal device is one of a plurality of terminal devices, and a third offset corresponding to any terminal device in the plurality of terminal devices is determined based on at least one of following information:
a location of the any terminal device;
a service type of the any terminal device;
a resource of the any terminal device; or
a network configuration of a first cell in which the plurality of terminal devices are located.

17. The method according to claim 1, wherein after the transmitting, by a terminal device, first information, the method further comprises:
transmitting, by the terminal device, second information, wherein the second information comprises another request for the OD-SIB1, wherein
a transmit power of the second information is greater than or equal to a transmit power of the first information.

18. The method according to claim 17, wherein the first information and the second information belong to a plurality of pieces of information in which the terminal device requests the OD-SIB1, and a transmission periodicity of at least two pieces of information whose transmitting times are later in the plurality of pieces of information is less than a transmission periodicity of at least two pieces of information whose transmitting times are earlier.

19. A method for wireless communication, comprising:
receiving, by a network device having a network energy saving (NES) function and from a terminal device, first information, wherein the first information comprises a request for an on demand system information block (OD-SIB1); and
transmitting, by the network device, first control signalling in a first time window to the terminal device, wherein the first control signalling indicates the terminal device to receive the OD-SIB1, a configuration parameter of the first time window is carried in configuration information of at least one of the first information or a first response, and the first response is feedback for the first information.

20. An Apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
transmitting, in a network energy saving (NES) cell, first information, wherein the first information comprises a request for a network device to transmit an on demand system information block (OD-SIB1); and
monitoring first control signalling in a first time window, wherein the first control signalling indicates the apparatus to receive the OD-SIB1, a configuration parameter of the first time window is carried in configuration information of at least one of the first information or a first response, and the first response is feedback for the first information.
